(19) United States
(12) Patent Application Publication
(10) Pub. No.: US 2017/0091234 A1
(43) Pub. Date: Mar. 30, 2017

(54) DATABASE COOPERATING SYSTEM AND DATABASE COOPERATING PROGRAM

(71) Applicant: ZEKKO INC., Sapporo-shi (JP)

(72) Inventors: Koji Ito, Sapporo-shi (JP); Yohei Hizume, Sapporo-shi (JP); Yu Fukuzawa, Sapporo-shi (JP)

(21) Appl. No.: 15/279,766

(22) Filed: Sep. 29, 2016

(30) Foreign Application Priority Data
Sep. 29, 2015 (JP) 2015-191898

(51) Int. Cl. G06F 17/30

(52) U.S. Cl. CPC G06F 17/30303; G06F 17/30371; G06F 17/30569

(57) ABSTRACT

To enable databases to be integrated by creating a cleansing definition interactively without depending on a batch processing and performing cleansing in real time.

There are provided a designating operation accepting unit 11 for accepting a designation of a data item of a processing target, a function for converting a data granularity, and a parameter to be used for the function respectively in relation to a selected table, a cleansing executing unit 12 for generating an SQL sentence based on a designated content and executing a cleansing processing in accordance with the SQL sentence, and previewing a result of the execution, and a virtual table saving unit 13 for saving SQL defining the cleansing processing as a virtual table in a storing unit 20, and a user can create a proper cleansing definition while optionally designating a data item, a function and a parameter and confirming an execution result of the cleansing processing based on the designated content through preview.

### TECHNICAL FIELD

The present invention relates to a database cooperating system and a database cooperating program, and more particularly, is suitably used in a database cooperating system which constructs a virtual database by integrating data of tables stored in a plurality of different databases, thereby performing cooperation between the databases.

### BACKGROUND ART

Conventionally, there is known a database cooperating system in which data managed in a plurality of different databases are integrated to construct a single virtual database, thereby performing cooperation between the databases (for example, see Patent Documents 1 to 3). The database cooperating system of this type is used in the case in which data stored in different databases are integrated and analyzed to obtain new knowledge which cannot be acquired from only a single database, for example.

A processing for integrating data extracted from the databases includes a processing referred to as physical integration (ETL: Extract Transform Load) and a processing referred to a virtual integration (EII: Enterprise Information Integration). The physical integration performs physical integration for the data extracted from the respective databases. An integration result is offered, as a single view, to a user. Although the physical integration is suitable for performing a collective processing as a batch processing, it is not suited to the integration of data in real time.

On the other hand, referring to the virtual integration, necessary data are retrieved from each database on demand of retrieval from the user and virtual integration is performed for the retrieved data. Referring to the virtual integration, data present in the databases are collected and integrated in real time on demand of the user. Then, an integration result thereof is offered, as a single view, to the user. The virtual integration is not the batch processing. Therefore, it is possible to acquire and integrate data required by the user from the databases in real time.

When the different databases are to be thus cooperated, however, there is often caused a problem in that granularities of the data stored in the respective databases are not adapted to each other. In order to adapt the granularity of the data stored in one of the databases to that of data stored in the other database, there is required a function for converting the granularity of the data. In general, the function for converting the granularity of the data is referred to as cleansing. For example, a typical example of the cleansing processing includes a processing for converting a data format, a name identification processing and the like.

Referring to the data integrating system described in Patent Document 1, a large number of data sources can be subjected to queries. As a result, data received from the data sources are subjected to cleansing, coupled, modified or operated by another method so that it is possible to generate a report which is useful for business by using the data thus processed.

Referring to the data integrating device described in Patent Document 2, moreover, data are collected from an information source through a data model (a physical model) at each information source side. On the other hand, in the integration processing, there are performed a processing (mapping) for converting a data structure toward a data model (a logic model) defined previously for each application on a utilization side and a processing (cleansing) for carrying out conversion to arrange respective values. Then, results of the processings are offered as views (logic models) for each application to the application on the utilization side.

The architecture of the integration engine (definition of the mapping) described in the Patent Document 2 serves to define a logic model based on the physical model which has been defined. Herein, the information source represents a plurality of systems (logic models) and the utilization side is a logic model required by the systems. Specifically, a necessary item is first set to the logic model from the physical models. A column name, a type, a type attribute and a limitation inherited from the physical model are set to the logic model and mapping definition is also created automatically. Next, necessary modification is performed for the logic model. For example, the correction includes deletion of an unnecessary column, a change in the column name, a change in the type, a change in the type attribute and the like. These changes are reflected on the mapping definition and the cleansing definition.

Referring to the name identification database design support system described in Patent Document 3, basic data item definition and requirements related to name identification are input so that a scalable name identification database can be designed in a short time corresponding to desirable requirements. The patent Document 3 describes that a table structure and a link structure in a name identification database are output in database definition sentences in an SQL language format.

### PRIOR ART DOCUMENT

### Patent Document

[Patent Document 1] Japanese Unexamined Patent Application Publication No. 2008-511934

[Patent Document 2] Japanese Laid-Open Patent Publication No. 2011-258225

[Patent Document 3] Japanese Laid-Open Patent Publication No. 2004-303117

[Patent Document 4] Japanese Laid-Open Patent Publication No. 7-36977

### SUMMARY OF THE INVENTION

### Problems to be Solved

As described above, when integrating the data extracted from the databases, it is possible to acquire and integrate data required by a user from the databases in real time by using a virtual integrating method. However, it is possible to integrate the data in real time on the assumption that granularities of the data to be acquired from the respective databases are adapted to each other.

In the case in which the granularities of the data are not adapted to each other, it is necessary to perform a processing for adapting the granularity of the data through cleansing. However, the cleansing is conventionally carried out by trial and error through a batch processing. Therefore, there is a problem in that a long time is taken before creation of cleansing definition meeting the demand of the user. Moreover, expert knowledge is required. For this reason, there is also a problem in that an end user cannot easily perform the cleansing.

There is disclosed a system for checking presence of a different person with the same pronunciation and that of the same family member in a conversation format over a kana name inquiry screen and an eaves/telephone name identification inquiry screen to perform family name identification in initial registration of client data (for example, see Patent Document 4). However, the Patent Document 4 describes that when client data are transmitted from a terminal device in order to be initially registered, attribute information thereof is checked to confirm the presence of the different person with the same pronunciation and that of the same family member and register the client data. This technique cannot be exactly applied to necessary cleansing for the database cooperation.

The present invention has been made to solve the problems and has an object to enable creation of a cleansing definition interactively without depending on a batch processing, thereby enabling cleansing to be performed in real time to integrate databases on demand of a user.

### Means for Solving the Problems

In order to solve the problems, in the present invention, a data item of a processing target, a function for converting a data granularity and a parameter to be used for the function are designated respectively through a cleansing screen including an interface capable of performing a user operation to execute a cleansing processing in relation to any of the tables which is selected, and a result of the execution is previewed on the cleansing screen. Herein, an SQL sentence is generated based on a content designated through the cleansing screen and the cleansing processing is executed for the selected table in accordance with the SQL sentence, and SQL defining the cleansing processing is saved as a virtual table in a storing unit.

### Effects of the Invention

According to the database cooperating system having the structure described above in accordance with the present invention, a user utilizing the system can create a proper cleansing definition while optionally designating a data item, a function and a parameter through the cleansing screen and confirming a result of the execution of the cleansing processing based on the designated content through preview. Moreover, since the virtual table generated by the cleansing processing is saved by the SQL, the tables can easily be integrated by the SQL. According to the present invention, consequently, the cleansing definition can be created interactively without depending on a batch processing and the databases can be integrated by performing the cleansing in real time on demand of the user.

### BRIEF DESCRIPTION OF THE DRAWINGS

FIG. 1 is a diagram showing an example of a whole structure of a database cooperating system according to the present embodiment.

FIG. 2 is a diagram showing an example of a schematic structure of a virtual database to be generated by the database cooperating system according to the present embodiment.

FIG. 3 is a block diagram showing an example of a functional structure of the database cooperating system according to the present embodiment.

FIG. 4 is a diagram showing an example of a cleansing screen to be displayed when accepting an operation for selecting a table.

FIG. 5 is a diagram showing an example of a cleansing screen to be displayed when “remarks” is designated as a target column and “conversion” is designated as a function.

FIG. 6 is a diagram showing an example of cleansing in a state in which an execution result of a cleansing processing is previewed.

FIG. 7 is a diagram showing an example of a cleansing screen to be displayed as a result of execution of four-time cleansing processing's.

FIG. 8 is a diagram showing an example of a logical mapping creation screen in a state in which an extraction tab is selected.

FIG. 9 is a diagram showing an example of a logical mapping creation screen in a state in which a condition tab is selected.

FIG. 10 is a diagram showing an example of a logical mapping creation screen in a state in which a join tab is selected.

### EMBODIMENT FOR CARRYING OUT THE INVENTION

An embodiment according to the present invention will be described below with reference to the drawings. FIG. 1 is a diagram showing an example of a whole structure of a database cooperating system according to the present embodiment. As shown in FIG. 1, a database cooperating system 100 according to the present embodiment integrates data of tables stored in databases 201 and 202, thereby constructing a virtual database 300 to perform cooperation between the databases 201 and 202.

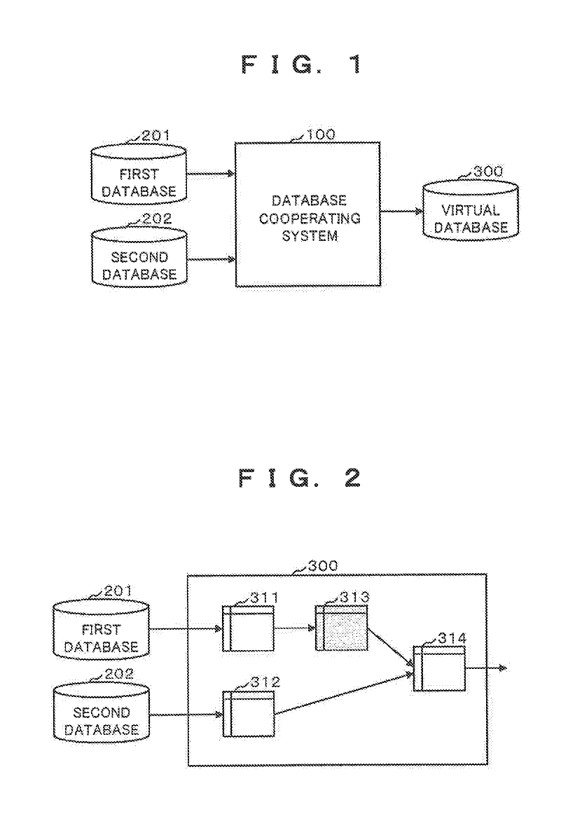

FIG. 2 is a diagram showing an example of a schematic structure of the virtual database 300 to be generated by the database cooperating system 100 according to the present embodiment. As shown in FIG. 2, the virtual database 300 according to the present embodiment is configured from physical mapping tables 311 and 312, a cleansing table 313 and a logical mapping table 314. The physical mapping tables 311 and 312 are virtual tables for external data source reference which is defined to acquire data of a physical table from the databases 201 and 202.

The cleansing table 313 is a virtual table that is to be generated as a result of execution of cleansing which will be described below through fetch of data of any of the physical tables from the first database 201 by the first physical mapping table 311, for example, and that includes information obtained by defining the cleansing operation through SQL.

Herein, data subjected to the cleansing through SQL of the cleansing table 313 has a granularity which is coincident with the granularity of the data of the physical table fetched from the second database 202 through the second physical mapping table 312. Although the description has been given to the example in which the data fetched from the second database 202 through the second physical mapping table 312 is not subjected to the cleansing, the cleaning may be further performed over the data of the second database 202.

The logical mapping table 314 is obtained by integrating two tables 312 and 313 in which the granularities of the data are coincident with each other as described above. The logical mapping table 314 is a virtual table in which a so-called view definition for SQL is performed. Information of the logical mapping table 314 to be this view is offered to an application and a necessary processing is performed in the application, for example.

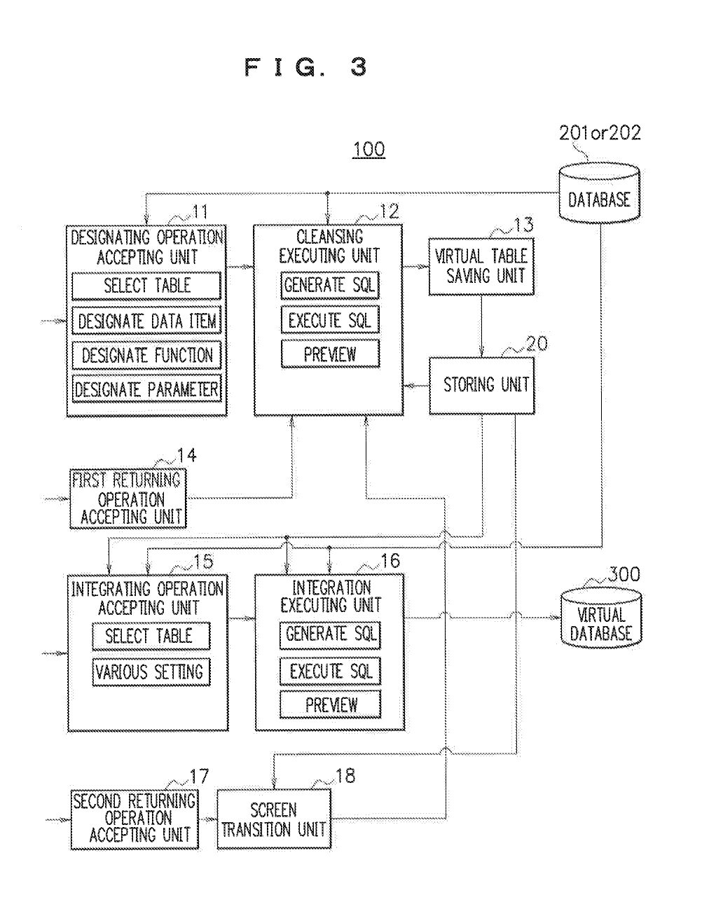

FIG. 3 is a block diagram showing an example of a functional structure of the database cooperating system 100 according to the present embodiment. As shown in FIG. 3, the database cooperating system 100 according to the present embodiment includes, as a functional structure thereof, a designating operation accepting unit 11, a cleansing executing unit 12, a virtual table saving unit 13, a first returning operation accepting unit 14, an integrating operation accepting unit 15, an integration executing unit 16, a second returning operation accepting unit 17 and a screen transition unit 18. Moreover, the database cooperating system 100 according to the present embodiment includes the storing unit 20 as a data storage medium.

The database cooperating system 100 including the respective function blocks 11 to 18 is configured as a server device connected to internet, for example. Moreover, the database cooperating system 100 can also be configured as a server device connected to an office LAN (Local Area Network). Alternatively, the database cooperating system 100 can also be configured as a personal computer which is not connected to a network.

The respective functional blocks 11 to 18 can also be configured from any of hardware, a DSP (Digital Signal Processor) and software. For example, in the case in which the respective functional blocks 11 to 18 are configured from the software, they actually include a CPU, an RAM, an ROM and the like in a server device, a personal computer or the like and is implemented by an operation of a program stored in a storage medium such as an RAM, an ROM, a hard disk or a semiconductor memory.

The designating operation accepting unit 11 accepts an operation for selecting any of physical tables constituting the databases 201 and 202, thereby displaying a cleansing screen which will be described below. Then, the designating operation accepting unit 11 accepts an operation for designating a data item of a processing target, a function for converting a data granularity and a parameter to be used for the function respectively through the cleansing screen.

There will be supposed the case in which the first physical mapping table 311 related to the first database 201 and the second physical mapping table 312 related to the second database 202 are integrated to generate the single logical mapping table 314 as shown in FIG. 2 when the first database 201 includes at least one physical table and the second database 202 also includes at least one physical table, for example.

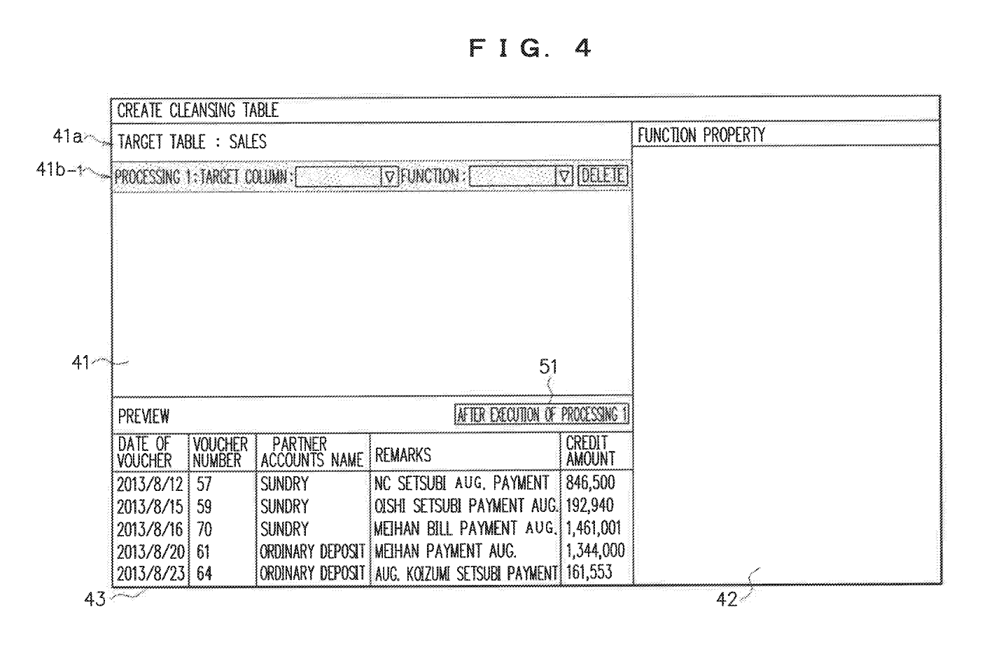

In this case, if the cleansing is performed by setting, as a target, a physical table fetched from the first database 201 (which will be hereinafter indicated as a physical table 311P for convenience of explanation) through the first physical mapping table 311, the designating operation accepting unit 11 first accepts an operation for selecting a desirable physical table 311P from the first database 201. When accepting the operation for selecting the physical table 311P, the designating operation accepting unit 11 displays a cleansing screen including an interface capable of performing a user operation. FIG. 4 is a diagram showing an example of the cleansing screen to be displayed at this time.

In the example of FIG. 4, a “sales table” is selected as the physical table 311P from the first database 201. As shown in FIG. 4, the cleansing screen has a processing designating region 41, a function property designating region 42 and a preview region 43. The processing designating region 41 includes a target table display field 41a and a cleansing processing designating field 41b₋₁. FIG. 4 shows a state in which a table name (sales) of the selected physical table 311P is displayed on the target table display field 41a of the processing designating region 41, and furthermore, data corresponding to a predetermined number in the sales table are displayed on the preview region 43.

Next, the designating operation accepting unit 11 accepts an operation for designating a data item of a cleansing processing target, a function for data granularity conversion and a parameter to be used for the function respectively through the cleansing processing designating field 41_{b-1} and the function property designating region 42 in the cleansing screen displayed as shown in FIG. 4. In the present embodiment, a target column is designated as the data item of the processing target. The target column and the function can be selected and designated from a pulldown menu, respectively. The data item to be displayed on the pulldown menu of the target column is actually possessed by the selected sales table and is extracted from each column of the sales table. On the other hand, the function to be displayed on the pulldown menu is prepared in advance.

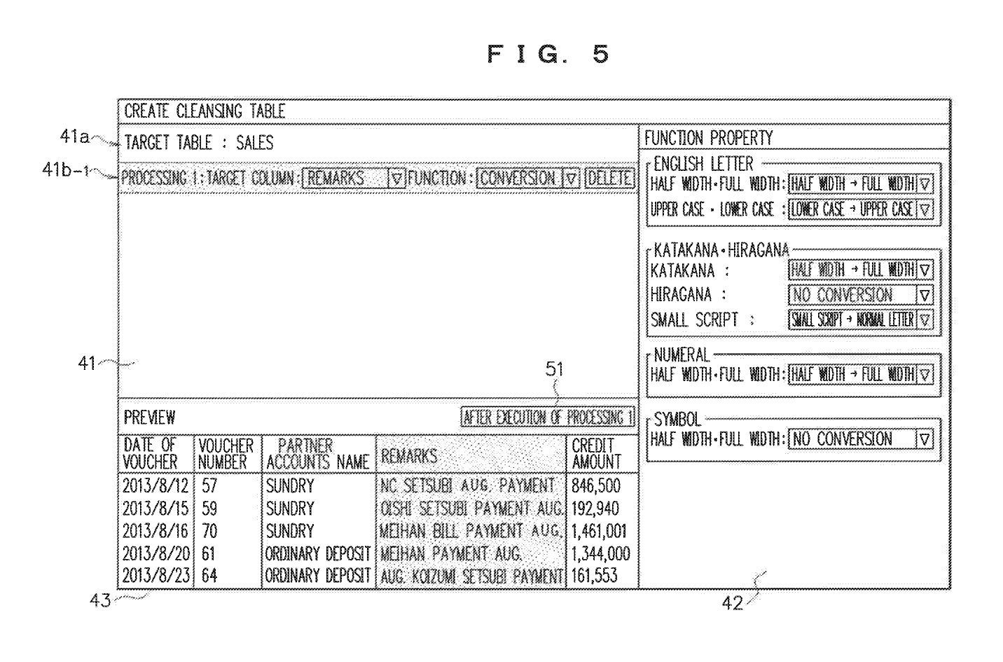

FIG. 5 is a diagram showing an example of a cleansing screen to be displayed in the case in which the “remarks” is designated as the target column and “conversion” is designated as the function. As shown in FIG. 5, when the “remarks” is designated as the target column in the cleansing processing designating field 41b_{—1}, the designated “remarks” column is highlighted and displayed in the preview region 43. The “conversion” designated as the function serves to execute conversion of full width and half width, conversion of a upper case and a lower case and conversion of a small script and a normal letter. Detailed setting related to the conversion can be designated as a parameter to be used for the function in the function property designating region 42.

The cleansing executing unit 12 in FIG. 3 generates an SQL sentence based on the designated content which is accepted by the designating operation accepting unit 11. Then, the cleansing executing unit 12 executes the cleansing processing over the selected physical table 311P in accordance with the generated SQL sentence and previews an execution result thereof in the preview region 43 of the cleansing screen. In other words, when a “after execution of processing 1” button 51 is pressed down in the cleansing screen of FIG. 5, the cleansing executing unit 12 executes a processing of “conversion” designated as the function over data on the “remarks” column designated as the target column in accordance with a condition designated in the function property designating region 42.

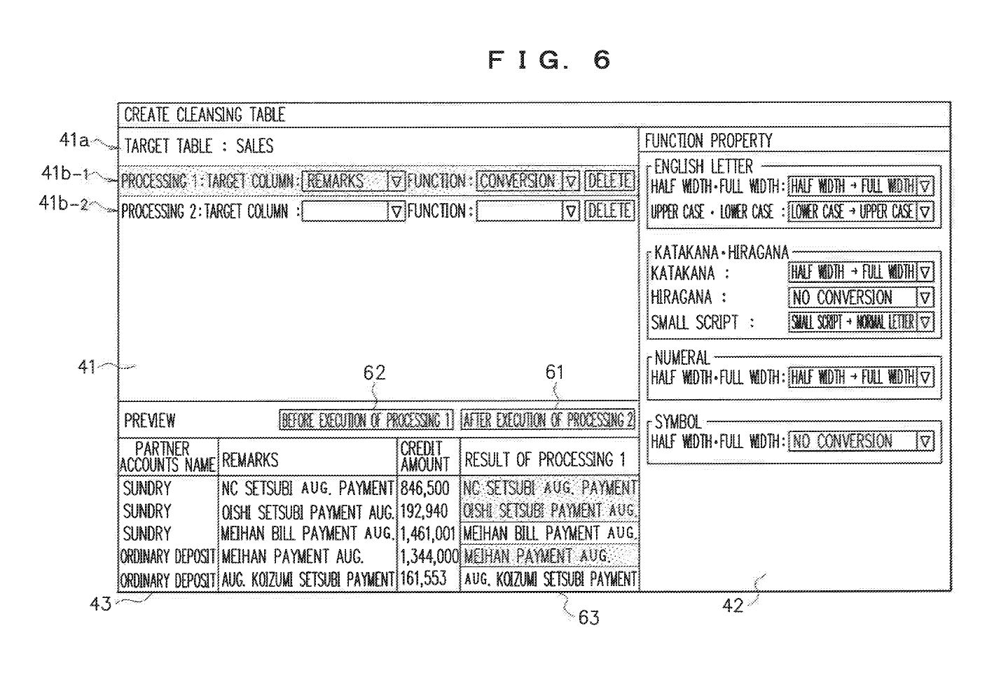

At this time, the cleansing executing unit 12 generates the content of the function as an SQL sentence and executes the SQL sentence, thereby executing the designated cleansing processing. Then, the cleansing executing unit 12 previews the execution result of the cleansing processing in the preview region 43. FIG. 6 is a diagram showing a state in which the preview is performed. In the present embodiment, the result of the cleansing processing is always output as a new column 63 and a cell to which the cleansing is applied is highlighted and displayed.

When the cleansing executing unit 12 executes the cleansing processing, the designating operation accepting unit 11 displays a “before execution of processing 1” button 62 on the left side of the “after execution of processing 2” button 61. The “before execution of processing 1” button 62 serves to indicate to return into a state brought before the execution of the cleansing processing.

When the cleansing executing unit 12 executes the cleansing processing, moreover, the designating operation accepting unit 11 adds and displays a second cleansing processing designating field 41b₋₂ under the cleansing processing designating field 41b₋₁. The second cleansing processing designating field 41b₋₂ is a user interface for designating the content of the second cleansing processing to be executed subsequently to a first cleansing processing. Thus, the designating operation accepting unit 11 displays, on the cleansing screen, a user interface for additionally accepting designation of a set of the target column, the function and the parameter after the execution of the first cleansing processing.

The designating operation accepting unit 11 can accept new designated contents of the target column and the function through the second cleansing processing designating field 41b₋₂. Moreover, the designating operation accepting unit 11 can accept a new designated content related to a parameter to be used for a newly designated function through the function property designating region 42 to be displayed corresponding to the newly designated function.

In the case in which the designating operation accepting unit 11 accepts the new designated contents of the set of the target column, the function and the parameter through the second cleansing processing designating field 41b₋₂ and the function property designating region 42, the cleansing executing unit 12 generates a new SQL sentence based on the new designated content. Then, the cleansing executing unit 12 executes the cleansing processing for the selected sales table in accordance with the new SQL sentence and previews a result of the execution in the preview region 43 of the cleansing screen.

When the designating operation accepting unit 11 is to accept new designation of the target column through the second cleansing processing designating field 41b₋₂, it can also accept the designation of the execution results of the cleansing processing at a last time and therebefore (the designation of the same column as that of the last time). Specifically, the designating operation accepting unit 11 additionally displays a data item which can designate the execution result of the cleansing processing at the last time and therebefore in a list of the data item to be displayed on the pulldown menu of the target column.

In the case in which the execution results of the cleansing processing at the last time and therebefore are designated as the target column, the cleansing executing unit 12 generates an SQL sentence obtained by mixing an SQL sentence of the cleansing processing at the last time and therebefore and an SQL sentence related to a present designated content. Then, the cleansing executing unit 12 executes the cleansing processing for the selected table in accordance with the composite SQL sentence and previews the result of the execution in the preview region 43.

For example, it is assumed that a function designated by the first cleansing processing is represented by “f₁”, an SQL sentence for executing the cleansing processing by application of the function f₁ to the remarks column (an SQL sentence generated by the cleansing executing unit 12 in the first cleansing processing) is represented by “f₁ (remarks column)”, and the function designated by the second cleansing processing is represented by “f₂”. In this case, if the execution result of the first cleansing processing is designated as the target column applying the function f₂ in the second cleansing processing, the cleansing executing unit 12 generates a composite SQL sentence of “f₂ (f₁ (remarks column))” and executes the cleansing processing in accordance with the composite SQL sentence.

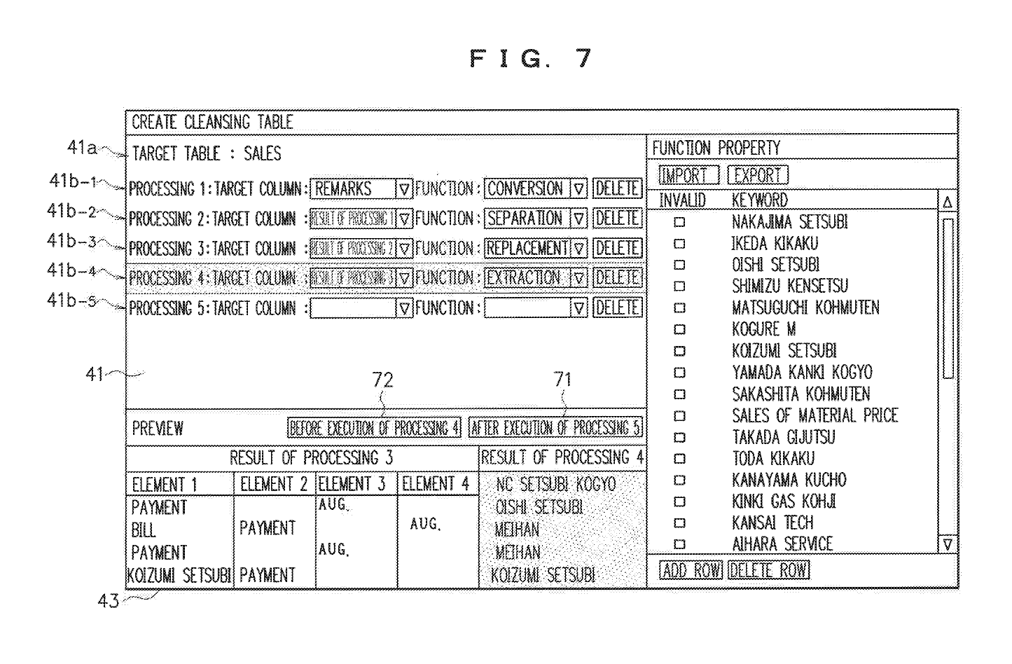

After a third time, similarly, the set of the target column, the function and the parameter can be designated to execute the cleansing processing and the result of the execution can be previewed in the preview region 43. FIG. 7 is a diagram showing an example of the cleansing screen to be displayed as a result of the execution of a four-time cleansing processings. In this example, the execution result of the first cleansing processing is designated as the target column when the second cleansing processing is to be performed. When the third cleansing processing is to be performed, moreover, the execution result of the second cleansing processing is designated as the target column. When the fourth cleansing processing is to be performed, the execution result of the third cleansing processing is designated as the target column.

An “after execution of processing 5” button 71 and a “before execution of processing 4” button 72 are displayed on the cleansing screen of FIG. 7 which is to be displayed as a result of execution of the four cleansing processings. The “after execution of processing 5” button 71 serves to indicate the execution of fifth cleansing processings. On the other hand, the “before execution of processing 4” button 72 serves to indicate a return to a state brought before the execution of the fourth cleansing processing (a state in which the third cleansing processing is executed).

The virtual table saving unit 13 of FIG. 3 saves SQL defining the cleansing processing executed by the cleansing executing unit 12 as a virtual table in the storing unit 20. The SQL to be stored in the storing unit 20 maybe an SQL sentence itself generated by the cleansing executing unit 12 or may be a set of a structure and variables which is enough for constructing the SQL sentence.

In the case in which the designating operation accepting unit 11 accepts a new designated content of a set of a target column, a function and a parameter and the cleansing executing unit 12 generates a new SQL sentence based on the new designated content to execute the cleansing processing after the second time, the virtual table saving unit 13 additionally saves new SQL as a virtual table in the storing unit 20. In the case in which the cleansing executing unit 12 generates a composite SQL sentence to execute the cleansing processing, moreover, the virtual table saving unit 13 additionally saves the composite SQL as a virtual table in the storing unit 20.

As in the example described above, in the case in which the function f₁ is applied to the remarks column to execute the first cleansing processing, the virtual table saving unit 13 saves, in the storing unit 20, the SQL sentence “f₁ (remarks column)” or a set of a structure and a variable which are enough for constructing the SQL sentence. In the case in which the function f₂ is applied to the execution result of the first cleansing processing to execute the second cleansing processing, subsequently, the virtual table saving unit 13 additionally saves, in the storing unit 20, a composite SQL sentence “f₂ (f₁ (remarks column))” or a set of a structure and a variable which are enough for constructing the composite SQL sentence.

The first returning operation accepting unit 14 accepts a returning operation for a return to a designated content of any of the cleansing processings at a last time or therebefore executed by the cleansing executing unit 12. Specifically, the first returning operation accepting unit 14 accepts an operation of the “before execution of processing 1” button 62 illustrated in FIG. 6, the “before execution of processing 4” button 72 illustrated in FIG. 7 or the like.

In the case in which the first returning operation accepting unit 14 accepts the returning operation, the cleansing executing unit 12 reads, from the storing unit 20, SQL corresponding to the designated content designated by the returning operation and executes the cleansing processing in accordance with the SQL thus read. Then, the cleansing executing unit 12 displays a result of the execution in the preview region 43. For example, in the case in which the “before execution of processing 2” button (not shown) is operated when the second cleansing processing is ended so that two SQL sentences “f₁ (remarks column)” and “f₂ (f₁ (remarks column))” are saved in the storing unit 20, the cleansing executing unit 12 reads the SQL sentence “f₁ (remarks column)” from the storing unit 20 and executes the processing.

The integrating operation accepting unit 15 accepts an operation for arranging the tables 312 and 313 as objects on the logical mapping creation screen and integrating the tables 312 and 313. Herein, the integrating operation accepting unit 15 has such a feature that it is configured to enable acceptance of an operation for arranging, as an object in the logical mapping creation screen, the cleansing table 313 saved as SQL in the storing unit 20 as one of the tables 312 and 313.

In other words, after the cleansing table 313 is generated through the cleansing screen illustrated in FIGS. 4 to 7, when the two tables 312 and 313 are to be integrated, the cleansing screen is closed and another logical mapping creation screen is opened. Then, the two tables 312 and 313 are arranged as objects on the logical mapping creation screen to perform various setting operations for a table integrating processing.

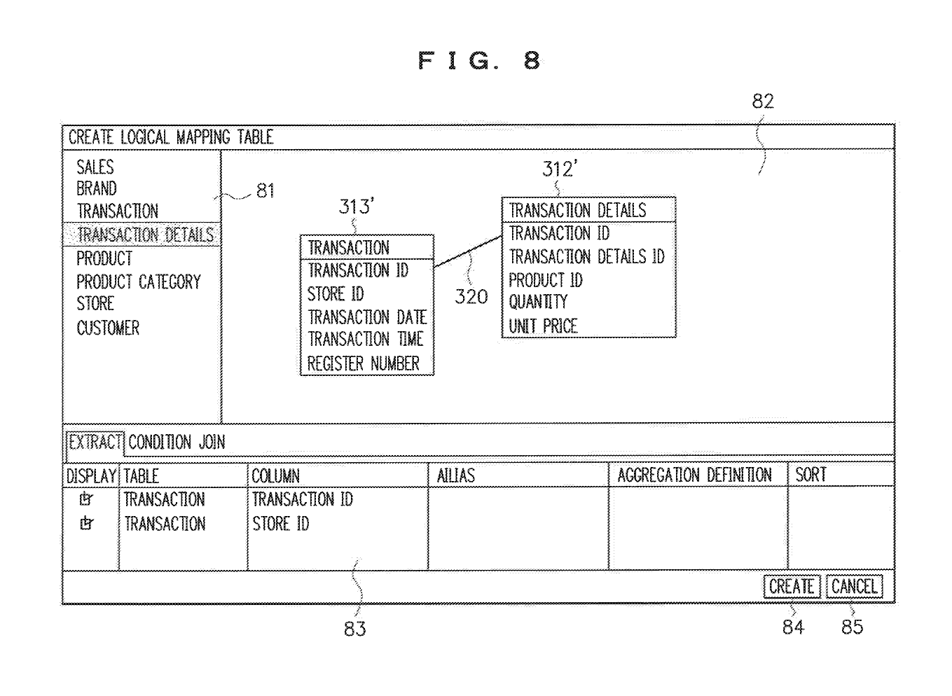

FIG. 8 is a diagram showing an example of the logical mapping creation screen. As shown in FIG. 8, the logical mapping creation screen has a table list region 81, an editor region 82 and a detail setting region 83. A creation button 84 and a cancel button 85 are displayed in the detail setting region 83.

The integrating operation accepting unit 15 accepts an operation for selecting two tables to be integrated from the table list region 81 and arranging them as table objects 312′ and 313′ in the editor region 82. For example, it is possible to arrange the table objects 312′ and 313′ in the editor region 82 by an operation for dragging and dropping a table name displayed in the table list region 81 to the editor region 82.

In the table objects 312′ and 313′ to be arranged in the editor region 82, a list of data items (column names) included in each table is displayed. Herein, it is possible to define join information of the tables 312 and 313 by making a link 320 through the drag and drop operation between an optional column included in the table object 313′ and an optional column included in the table object 312′. In the example of FIG. 8, there is defined join information in which integration is performed by setting, as keys, “transaction ID” included in both of the tables 312 and 313.

The detail setting region 83 has three selectable tabs of extraction, condition and join. It is possible to define detail setting of table integration in each of them. In the case in which the extraction tab is selected, it is possible to perform detail setting related to a column to be extracted from the table in the integration. First of all, optional column names displayed in the table objects 312′ and 313′ are dragged and dropped to the detail setting region 83 of the extraction tab to designate an output column. Then, it is possible to designate alias, aggregation definitions, sorting information or the like if necessary in relation to the designated output column.

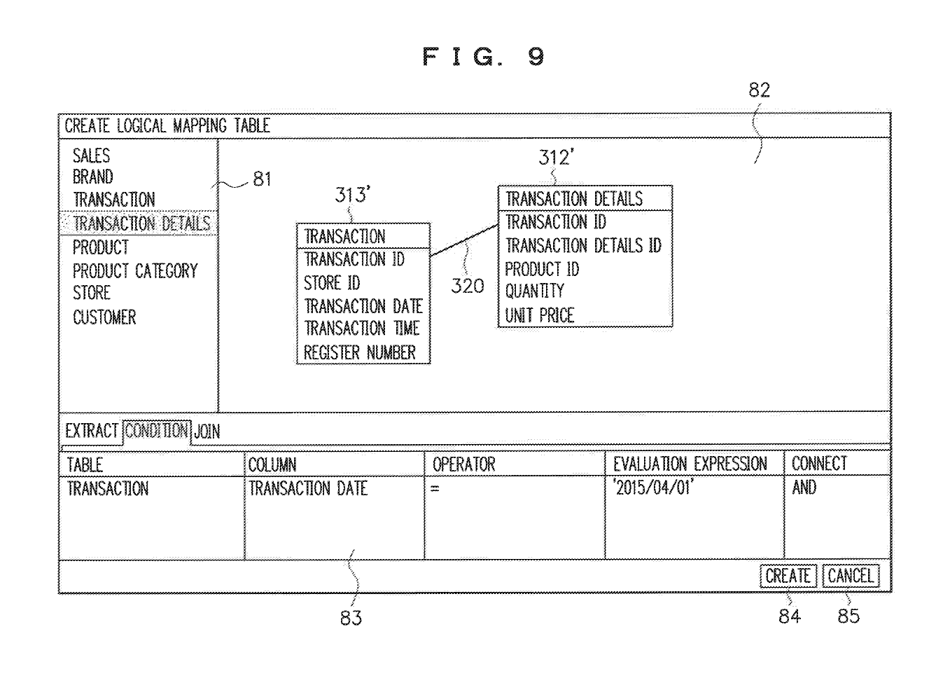

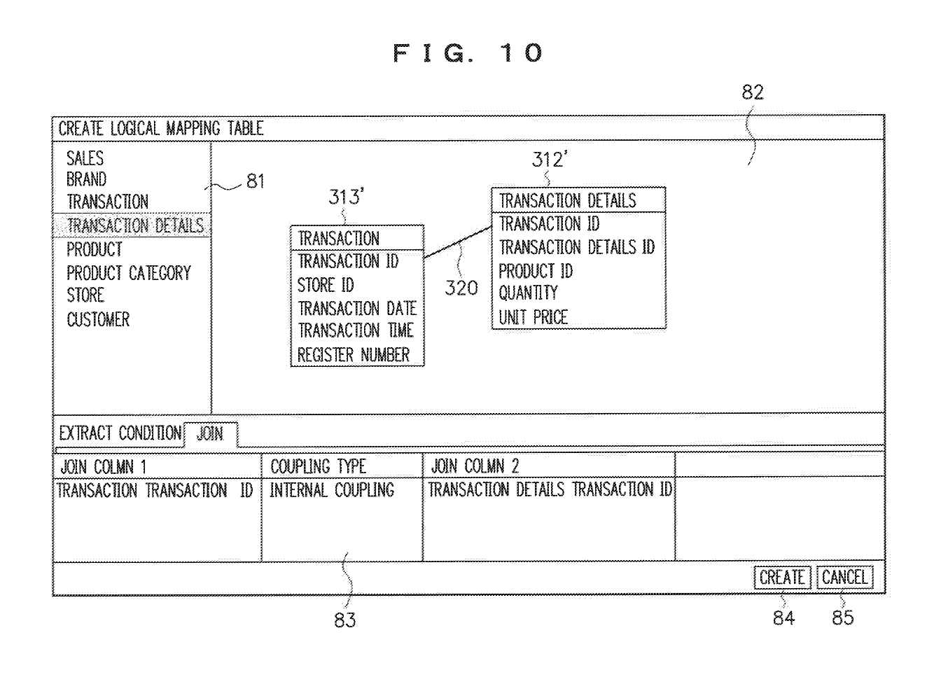

In the case in which the condition tab is selected as shown in FIG. 9, moreover, it is possible to perform detail setting related to a condition in the extraction of data from the table. First of all, optional column names displayed in the table objects 312′ and 313′ are dragged and dropped to the detail setting region 83 of the condition tab to designate a condition column. Referring to the designated condition column, then, it is possible to select an operator for a condition and to designate an evaluation expression by free description.

In the case in which the join tab is selected as shown in FIG. 10, furthermore, it is possible to perform detail setting in the join of two tables. In the detail setting region 83 of the join tab, it is possible to designate a join type (inner join, left outer join, right outer join, full outer join or the like).

The integration executing unit 16 generates an SQL sentence for table integration based on the content of the operation accepted by the integrating operation accepting unit 15, that is, various set contents obtained through the logical mapping creation screen as is illustrated in FIGS. 8 to 10 and executes the integration processing for the tables 312 and 313 in accordance with the SQL sentence. Consequently, the logical mapping table 314 shown in FIG. 2 is generated.

Specifically, when the integrating operation accepting unit 15 accepts the operation of the creation button 84, the integration executing unit 16 generates an SQL sentence corresponding to the detail setting for table integration designated in the detail setting region 83. Then, the integration executing unit 16 generates the logical mapping table (the integrated table) 314 by execution of the SQL sentence of the cleansing processing defined in the cleansing table 313 and the SQL sentence generated from the designated content in the detail setting region 83. The content of the logical mapping table 314 thus generated is displayed as a view.

The second returning operation accepting unit 17 accepts a second returning operation for a return from the logical mapping creation screen to the cleansing screen. It is possible to perform the second returning operation by designating the table object 313′ arranged in the editor region 82 of the logical mapping creation screen (an object of a virtual table subjected to the cleansing through the cleansing screen) and operating the return button to be displayed by a right click of a mouse, for example. This operation is only illustrative and is not restricted thereto. For example, the return button may be displayed on the logical mapping creation screen.

The screen transition unit 18 reads, from the storing unit 20, SQL corresponding to the cleansing table 313 arranged in the editor region 82 of the logical mapping creation screen when the second returning operation accepting unit 17 accepts the second returning operation. Then, the screen transition unit 18 executes the cleansing processing through the read SQL to redisplay the cleansing screen in a state in which the cleansing processing is executed.

As described above in detail, in the present embodiment, the target column, the function and the parameter to be used for the function are designated respectively to execute the cleansing processing through the cleansing screen in relation to any of the tables which is selected, and a result of the execution is previewed on the cleansing screen. Herein, an SQL sentence is generated based on the content designated through the cleansing screen and the cleansing processing is executed for the selected table in accordance with the SQL sentence, and SQL defining the cleansing processing is saved as a virtual table in the storing unit 20.

According to the present embodiment having such a structure, a user utilizing the system can create a proper cleansing definition while optionally designating the table, the target column, the function and the parameter through the cleaning screen and confirming the result of execution of the cleansing processing based on the designated content through preview. Moreover, the virtual table generated by the cleansing processing is saved through the SQL. Therefore, the tables can easily be integrated through the SQL. According to the present embodiment, consequently, it is possible to create the cleansing definition interactively without depending on a batch processing and to integrate databases by performing cleansing in real time on demand of a user.

In the present embodiment, moreover, it is possible to perform the cleansing processing plural times over the cleansing screen and to store the respective cleansing definitions as SQL in the storing unit 20. Herein, in the case in which a new column is designated as the data item of the processing target, a new SQL sentence is generated based on the new designated content to execute the cleansing processing so that the new SQL is additionally saved in the storing unit 20. In the case in which the results of execution of the cleansing processings at a last time and therebefore are designated as the data item of the processing target, moreover, there is generated an SQL sentence by mixing the SQL sentence of the cleansing processings at the last time and therebefore and an SQL sentence related to the present designated content to execute the cleansing processing, and the composite SQL is additionally saved in the storing unit 20.

Consequently, it is possible to designate how to perform the cleansing from various angles, thereby executing the cleansing processing. Through such a simulation, an optimum cleansing definition in the integration of two tables can easily be created.

In the present embodiment, moreover, the respective cleansing definitions generated by the cleansing processing performed plural times are stored as SQL in the storing unit 20. When granularities of data are not adapted well, consequently, the operation for returning to any of the cleansing processings at the last time and therebefore is performed over the cleansing screen and SQL corresponding to the returned cleansing processing is read from the storing unit 20 and is thus executed. Thus, it is possible to return to a desirable one of the cleansing processings, thereby re-editing the cleaning definition easily.

In the present embodiment, furthermore, the cleansing table 313 including the cleansing definition through SQL can be arranged as the table object 313′ on the logical mapping creation screen. By the characteristic structure, for example, when partial modification is required in the case in which a transition is made to the logical mapping creation screen to actually perform the table integration on the assumption that a simulation result of the cleansing definition on the cleansing screen is excellent, it is possible to re-edit the cleansing definition of the cleansing table 313 by returning to the cleansing screen from the logical mapping creation screen.

Although the description has been given to the example in which it is possible to return to a last cleansing processing by operating a button for returning to a last cleansing processing (the “before execution of processing 1” button 62 in FIG. 6 or the “before execution of processing 4” button 72 in FIG. 7) over the cleansing screen in the embodiment, the user interface of the returning operation is not restricted thereto. For example, it is also possible to employ a structure in which a direct return to a desirable cleansing processing designating field 41b₋ₙ is performed by an operation for double-clicking the desirable cleansing processing designating field 41b₋ₙ.

Although the description has been given to the example in which the two tables 312 and 313 are coupled to generate the single logical mapping table 314 in the embodiment, moreover, at least three tables can also be coupled.

Although the description has been given to the example in which a desirable one of the physical tables stored in the two databases 201 and 202 is selected to open the cleansing screen in the embodiment, furthermore, it is also possible to open the cleansing screen by selecting a logic table generated from the physical table.

In addition, the embodiment is only illustrative for concreteness to carry out the present invention and the technical scope of the present invention should not be thereby construed to be restrictive. In other words, the present invention can be carried out in various configurations without departing from the gist or main features thereof.

### EXPLANATION OF DESIGNATION

11 designating operation accepting unit
12 cleansing executing unit
13 virtual table saving unit
14 first returning operation accepting unit
15 integrating operation accepting unit
16 integration executing unit
17 second returning operation accepting unit
18 screen transition unit
20 storing unit
100 database cooperating system
201 first database
202 second database
300 virtual database
311 first physical mapping table
312 second physical mapping table
313 cleansing table
314 logical mapping table (integrated table)

1. A database cooperating system in which data of tables stored in databases are integrated to construct a virtual database, thereby performing cooperation between the databases, the system comprising:
a designating operation accepting unit for accepting an operation for selecting any of the tables constituting the databases to display a cleansing screen having an interface capable of performing a user operation and accepting an operation for designating a data item of a processing target, a function for conversion of a data granularity, and a parameter to be used for the function respectively through the cleansing screen;
a cleansing executing unit for generating an SQL sentence based on a designated content accepted by the designating operation accepting unit, executing a cleansing processing for the selected table in accordance with the SQL sentence and previewing a result of the execution on the cleansing screen; and
a virtual table saving unit for saving SQL defining the cleansing processing as a virtual table in a storing unit.

2. The database cooperating system according to claim 1, wherein
the designating operation accepting unit displays, on the cleansing screen, a user interface for accepting designations of the set of the data item of the processing target, the function and the parameter,
the cleansing executing unit generates a new SQL sentence based on a new designated content, executes a cleansing processing for the selected table in accordance with the new SQL sentence and previews a result of the execution on the cleansing screen when the designating operation accepting unit accepts the new designated content of a set of the data item of the processing target, the function and the parameter, and
the virtual table saving unit additionally saves new SQL as a virtual table.

3. The database cooperating system according to claim 2, wherein
when results of execution of the cleansing processing at a last time and therebefore are designated as the data time of the processing target, the cleansing executing unit generates a composite SQL sentence obtained by mixing an SQL sentence of the cleansing processings at the last time and therebefore and an SQL sentence related to a present designated content, executes the cleansing processing for the selected table in accordance with the composite SQL sentence and previews a result of the execution on the cleansing screen, and
the virtual table saving unit additionally saves the composite SQL as a virtual table.

4. The database cooperating system according to claim 2, further comprising a first returning operation accepting unit for accepting a first returning operation for returning to any of designated contents of the cleansing processing at the last time and therebefore executed by the cleansing executing unit,
the cleansing executing unit reading, from the storing unit, SQL corresponding to a designated content designated by the first returning operation and executing the cleansing processing in accordance with the read SQL when the first returning operation accepting unit accepts the first returning operation.

5. The database cooperating system according to claim 1, further comprising:
an integrating operation accepting unit for accepting an operation for arranging the tables as objects on a logical mapping creation screen and integrating the tables; and
an integration executing unit for generating an SQL sentence for table integration based on an operation content accepted by the integrating operation accepting unit and executing a processing for integrating the tables in accordance with the SQL sentence,
the integrating operation accepting unit accepting an operation for arranging, as the object on the logical mapping creation screen, the virtual table of SQL saved in the storing unit as one of the tables, and
the integration executing unit executing SQL of a cleansing processing corresponding to the virtual table and SQL for the table integration.

6. The database cooperating system according to claim 5, further comprising:
a second returning operation accepting unit for accepting a second returning operation for a return from the logical mapping creation screen to the cleansing screen; and
a screen transition unit for reading, from the storing unit, SQL corresponding to the virtual table arranged on the logical mapping creation screen and redisplaying a cleansing screen in a state in which a cleansing processing through the read SQL is executed when the second returning operation accepting unit accepts the second returning operation.

7. A database cooperating program which is stored in a non-transitory computer-readable medium for integrating data stored in databases to construct a virtual database and to perform cooperation between the databases, the program causing a computer to function as:
designating operation accepting means for accepting an operation for selecting any of the tables constituting the databases to display a cleansing screen having an interface capable of performing a user operation and accepting an operation for designating a data item of a processing target, a function for conversion of a data granularity, and a parameter to be used for the function respectively through the cleansing screen;
cleansing executing means for generating an SQL sentence based on a designated content accepted by the designating operation accepting means, executing a cleansing processing for the selected table in accordance with the SQL sentence and previewing a result of the execution on the cleansing screen; and
virtual table saving means for saving SQL defining the cleansing processing as a virtual table in a storing unit.
